(19) United States
(12) Patent Application Publication
(10) Pub. No.: US 2009/0100933 A1
(43) Pub. Date: Apr. 23, 2009

(54) Vibration Dosimeter and Method of Monitoring Vibration Dosage

(75) Inventors: Kevin Michael Brunson, Worcestershire (GB); Robin Davies, Worcestershire (GB); David Oury King, Worcestershire (GB); Russell Guy Taylor, Kent (GB); Richard John Weeks, Hampshire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED

(21) Appl. No.: 12/300,669

(22) PCT Filed: May 9, 2007
(86) PCT No.: PCT/GB2007/001714

§ 371 Date: Nov. 13, 2008

(30) Foreign Application Priority Data
May 15, 2006 (GB) 0609536.8

(51) Int. Cl. G01M 7/02

(52) U.S. Cl. 73/577

(57) ABSTRACT

A vibration dosimeter (2) adapted to monitor whole-body vibration comprising a sensor (6) arranged to continuously measure magnitude of mechanical vibrations received by a person being monitored, means for sampling the vibration measurements (20) produced by the sensor (6), and a processor (10) configured to analyse the vibration measurements and to record an analysis thereof to a data store internal to the dosimeter (2).

The present invention relates to a vibration dosimeter and to a method of measuring vibration dosage. In particular, the invention relates to a whole-body vibration dosimeter and to a method of measuring whole-body vibration dosage.

Regular long term exposure to mechanical shock and vibration (for example caused by power tools, machinery and vehicles) has been shown to be damaging to the human body. Such vibration can cause painful and disabling medical conditions including Hand and Arm Vibration Syndrome (HAVS), spinal injuries, abdominal and digestive system diseases and cardiovascular effects.

Mindful of the human and economic costs associated with vibration induced injuries, new legislation has been introduced which requires employers and employees to eliminate vibration risks or reduce exposure to as low a level as reasonably practicable. The relevant legislation in the United Kingdom is the Control of Vibration at Work Regulations 2005 which came into force in July 2005. These regulations implement European Council Directive 2002/44/EC on the minimum health and safety requirements regarding exposure of workers to the risks arising from physical agents (vibration). The relevant European legislation is the sixteenth individual directive within the meaning of Article 16(1) of Directive 89/391/EEC.

The Control of Vibration at Work Regulations 2005 refer to two types of vibration exposure, namely hand-arm vibration and whole-body vibration.

Hand-arm vibration relates to mechanical vibration transmitted into the hands and arms during a work activity. Hand-arm vibration is typically associated with use of hand-held or hand-controlled machinery or equipment.

Whole-body vibration relates to mechanical vibration which is transmitted into the body, when seated or standing, through a supporting surface (usually a seat or the floor) during or in connection with a work activity. Whole-body vibration is typically associated with driving or riding in certain types of vehicles, for example driving or riding on a vehicle along an unmade road, operating earth moving machines or standing on a structure attached to a large, powerful, fixed machine which is impacting or vibrating.

High levels of whole body vibration may be experienced by operators and drivers of off-road machinery such as construction, mining and quarrying machines, for example scrapers, bulldozers and building site dumpers, and tractors and other agricultural and forestry machinery. High exposures to whole-body vibration may also occur where vehicles designed for operation on smooth surfaces are driven on poor surfaces e.g. when lift trucks with no wheel suspension or with solid tyres are used on a cracked or uneven yard. High exposures also occur in small, fast boats.

As a consequence of the abovementioned legislation, employers are required to make an assessment of the risks to employees' health created by vibration in the workplace. The legislation also introduces restrictions on the quantity of mechanical vibration to which a worker shall be exposed during a working day (referred to as the daily exposure level and denoted in the legislation by the term A(8)) which takes account of the magnitude and duration of the vibration. The exposure action value set out in the legislation defines a daily exposure level which if exceeded requires specific action to be taken to reduce the associated risk. The daily exposure level must not exceed the exposure limit value as set out in the legislation.

The abovementioned restrictions on the quantity of mechanical vibration to which a worker is exposed during a working day increase the need to monitor vibration exposure levels in the workplace.

A traditional approach to determining hand-arm vibration exposure levels is to measure the vibration produced by a piece of machinery in order to classify the machinery, and then record the amount of time spent using the machinery. Similarly, the conventional approach to determining vehicle borne whole-body vibration exposure levels is to classify each particular type of vehicle, and then record the amount of time a person spends in each vehicle. However, this approach is rather cumbersome as well as being difficult to administer and somewhat inaccurate. For example, vibration exposure levels due to a vehicle travelling off-road, across open ground, can vary hugely depending on the speed and type of ground.

Alternatively, a vibration monitor can be used to continuously measure the vibration of a piece of machinery at the supporting surface (e.g. seat or floor) and whole-body vibration exposure levels determined there-from.

However, measuring vibration in this manner does not cater for situations where the occupant does not remain constantly in contact with the seat, in which case the measurements recorded at the seat are not representative of those experienced by the occupant. Loss of contact may occur due to severe vibration exposures or by the occupant leaving the seat, either to leave the vehicle, to obtain a better view or due to a preference to accept vibration through the legs rather than the seat. Post-processing of the measured seat accelerations is usually necessary to remove the resulting artefactual measurement events. This post-processing requires knowledge of the movements of the vehicle and/or the occupant and can be difficult to carry out using recorded vibration time histories alone.

An alternative to measuring vibration at the supporting surface is to mount an accelerometer directly to the human body. The main disadvantage with this approach for measuring vertical vibration is that the transducer is no longer positioned directly between the skeleton and the vibrating supporting surface.

The use of skin-mounted accelerometers has been investigated by a number of studies (e.g. Kitazaki, S and Griffin, M J (1995) A data correction method for surface measurement of vibration on the human body. Journal of Biomechanics 28, 7, 885-890; Pope, M H, Svensson, M, Broman, H and Andersson, G B J (1986) Mounting of the transducers in measurement of sequential motion of the spine. Journal of Biomechanics 19, 8, 675-677; Mansfield, N J and Griffin, M J (2000) Non-linearities in apparent mass and transmissibility during exposure to whole-body vertical vibration. Journal of Biomechanics, 33, 8, 933-941; Hinz, B and Seidel, H (1987) The nonlinearity of the human body in response during sinusoidal whole body vibration. Industrial Health 25, 169-181; Harazin, B and Grzesik, J (1998) The transmission of vertical whole-body vibration to the body segments of standing subjects. Journal of Sound and Vibration 215(4), 775-787), as has the mounting of accelerometers directly to the spine (e.g. Pope, 1986; Sandover, J and Dupuis, H (1987) A reanalysis of spinal column motion during vibration. Ergonomics 30, 975-985).

The use of accelerometers connected to the skeleton has obvious practical difficulties for use in the field with large subject populations, but some authors have proposed methods of correcting the acceleration measured on the skin adjacent to the spine to estimate the acceleration of the vertebrae (see for example Hinz, B, Seidel, H, Bräuer, D, Menze, D, Blüthner, R and Erdmann, U (1988) Bidimensional accelerations of lumbar vertebrae and estimation of internal spinal load during sinusoidal vertical whole-body vibration: a pilot study. Clinical Biomechanics, 3, 241-248; Smeathers, J E (1989) Measurement of transmissibility for the human spine during walking and running. Clinical Biomechanics (4), 34-40; Kitazaki and Griffin, 1995).

Mounting an accelerometer on the back may not be ideal for obtaining vibration exposure measurements in field conditions where a backrest is present. The mechanisms of coupling between the spine and the backrest are complex and the shear stiffness of the skin (Kitazaki and Griffin, 1995) for displacements of a few millimetres may be less than the shear stiffness of the backrest (Mills ands and Gilchrist, 2000).

A practical alternative transducer position may be on the abdomen. However, in previous studies measurements of vertical vibration on the abdomen have shown considerable inter-subject variability in the 4 to 8 Hz region for the subjects tested (see Mansfield, N J and Griffin, M J (2000) Non-linearities in apparent mass and transmissibility during exposure to whole-body vertical vibration. Journal of Biomechanics, 33, 8, 933-941).

Accordingly, it has not hitherto been thought practical to use body-mounted transducers for measuring whole-body vibration due to the complex manner in which vibrations are transferred between the supporting structure and the internal structures of the body (spine etc.).

Notwithstanding the foregoing, new research undertaken by the applicant has revealed that measurements of vertical vibration exposure at particular points on the body (for example at the iliac crest (hip bone)), of seated subjects may be an acceptable alternative to measurements at the seat-person interface. Indeed, the new studies have unexpectedly shown that weighted root-mean-square (r.m.s.) accelerations and vibration dose values (VDVs) measured at the hip in response to a variety of motions were generally comparable with that measured on the seat surface.

Hence, contrary to accepted wisdom, the use of a hip-mounted transducer provides a practical method for measuring vertical whole-body vibration exposure and hence, in this respect, the present invention overcomes a technical prejudice in the art.

Furthermore, Applicant's research has also unexpectedly shown that a good measure of whole-body vibration dose is obtainable from vibration measurements made along a single axis only, namely in a substantially vertical direction (z-axis).

Traditionally, whole-body vibration is measured in all three axes, vertically along a z-axis (up the spine), and laterally along an x-axis (forwards and backwards) and a y-axis (side to side). These three measurements are conventionally weighted using different filter functions before being combined into the whole-body vibration exposure measurement.

However, Applicant's studies have unexpectedly revealed that in most circumstances the contribution to the whole-body vibration dose of the lateral vibrations is very small and that a good measure of whole-body vibration dose is obtainable from the vertical vibration measurement only.

Hence, contrary to accepted wisdom, the use of a single axis (z-axis) hip-mounted transducer provides a practical method and sensing means for measuring vertical whole-body vibration exposure. Thus, in this respect, the present invention overcomes a technical prejudice in the art.

With general regard to dosimeters, personal vibration monitors are known for monitoring hand-arm vibration exposure, for example see GB 2411472, GB 2299168, and U.S. Pat. No. 6,490,929. However, none of the personal vibration monitors described in the abovementioned documents are used to measure whole-body vibration.

Experiments have shown that in order to accurately determine daily whole-body vibration exposure levels it is not sufficient to take periodic spot measurements of vibration since important vibration peaks can be missed and it is these peaks that can cause damage to the body.

Hence, the personal vibration monitors described in the abovementioned documents are not suitable for measuring whole-body daily vibration exposure levels as defined in the new legislation as they lack the requisite continuous data monitoring capability, data sampling frequency/rate, data storage capacity, battery capacity and data processing capabilities. By way of explanation, the personal vibration monitor described in GB 2411472 merely records data periodically (every ten seconds), whereas data must be recorded substantially continuously in order to determine whole-body daily vibration exposure levels as specified in the new legislation.

Accordingly, it is an object of the invention to provide a method of measuring whole-body vibration dosage which mitigates at least some of the disadvantages of the conventional methods described above. It is a further object of the invention to provide a personal whole-body vibration dosimeter.

According to a first aspect of the present invention, there is now proposed a vibration dosimeter adapted to monitor whole-body vibration comprising a sensor arranged in use to continuously measure magnitude of mechanical vibrations, means for sampling the vibration measurements produced by the sensor, and a processor configured to analyse the vibration measurements to determine whole-body vibration and to record an analysis thereof in a data store internal to the dosimeter.

In the interests of clarity, whole-body vibration as referred to herein is mechanical vibration which is transmitted into the human body through a supporting surface. Without limitation, such mechanical vibration may arise during or in connection with a work activity.

Preferably, the vibration dosimeter is adapted in use to be worn on or at the hip of a person being monitored. Alternatively, the vibration dosimeter is adapted in use to be worn on or at the base of the spine of a person being monitored.

In a preferred embodiment, the vibration dosimeter further comprises means for filtering the sampled vibration measurements so as to emphasise vibrations corresponding substantially with modes of vibration of the human body.

Advantageously, the analysis of the vibration measurements comprises a frequency weighted root-mean-square acceleration time-history. Conveniently, the analysis includes cumulative frequency-weighted root-mean-square acceleration.

Alternatively, or in addition, the analysis of the vibration measurements comprises a frequency-weighted vibration dose value time-history. Conveniently, the analysis comprises cumulative frequency-weighted vibration dose value.

In another preferred embodiment, the vibration dosimeter is capable of recording an analysis of vibration measurements for a period of exposure of eight hours or more.

Preferably, the vibration dosimeter has a power consumption which is controllable in use by switching the processor between an active state and a sleep state. In use, the processor may adopt the sleep state while the sampling means samples and temporarily stores a plurality of vibration measurements produced by the sensor.

Conveniently, the processor is adapted in use to periodically adopt the active state during which state it processes the plurality of vibration measurements to produce the analysis thereof.

In a preferred embodiment, the sensor comprises a micro-electromechanical-systems (MEMS) accelerometer.

The micro-electromechanical-systems (MEMS) accelerometer may have a plurality of measurement axes. For example, the sensor may comprise a three-axis micro-electromechanical-systems (MEMS) accelerometer.

Alternatively, the sensor may comprise a single-axis micro-electromechanical-systems (MEMS) accelerometer. The use of single axis accelerometer has a number of advantages in the present vibration dosimeter. Firstly, it enables power to be conserved within the dosimeter since there is only one accelerometer and associated analogue electronics. In addition, digital processing of the accelerometer output is reduced to one filter allowing the processor to enter its sleep state for longer. The use of single-axis accelerometer has been proven in Applicant's research which indicates that a good measure of whole-body vibration dose is obtainable from vibration measurements made along a single axis only, namely in a substantially vertical direction (z-axis).

Preferably, the MEMS accelerometer is adapted to measure accelerations within a range ±10 g. Even more preferably, the MEMS accelerometer is adapted to measure accelerations within a range ±25 g.

Hence, the vibration dosimeter according to the first aspect of the present invention may be used to measure whole-body vibration exposure.

According to a second aspect of the present invention, there is now proposed an apparatus for analysing whole-body vibration comprising a dosimeter according to the first aspect of the present invention and means for retrieving the analysis of the vibration measurements from the dosimeter.

In a preferred embodiment, the apparatus further comprises a computer arranged in use to receive the analysis of the vibration measurements from the retrieving means and to store the analysis in a database.

In another preferred embodiment, the apparatus is adapted to identify from the analysis of the vibration measurements any vibration exposure in excess of a daily exposure limit value. Alternatively, or in addition, the apparatus is adapted to identify from the analysis of the vibration measurements any vibration exposure in excess of a daily exposure action value.

Advantageously, the apparatus is adapted to calculate daily vibration exposure from the analysis of the vibration measurements.

According to a third aspect of the present invention, there is now proposed a method of measuring whole-body vibration exposure comprising the steps of:
(i) attaching to a person to be monitored a vibration dosimeter according to the first aspect of the invention,
(ii) measuring magnitude of mechanical vibrations received by the person being monitored,
(iii) analysing the vibration measurements and recording the analysis thereof in a data store internal to the dosimeter,
(iv) retrieving the analysis of the vibration measurements from the dosimeter, and
(v) storing the analysis of the vibration measurements in a database.

Preferably, the step of attaching the vibration dosimeter comprises attaching the dosimeter on or at the hip of the person to be monitored. Alternatively, the step of attaching the vibration dosimeter may comprise attaching the dosimeter on or at the base of the spine of the person to be monitored.

Advantageously, the method comprises the further step of:
(vi) calculating daily vibration exposure from the analysis of the vibration measurements.

Conveniently, the method comprises the further step of:
(vii) identifying from the analysis of the vibration measurements any vibration exposure in excess of a daily exposure limit value.

Preferably, the method comprises the further step of:
(viii) identifying from the analysis of the vibration measurements any vibration exposure in excess of a daily exposure action value.

According to another aspect of the present invention, there is now proposed a method of surveying whole-body vibration exposure comprising the steps of:
(i) providing a vibration dosimeter according to the first aspect of the present invention for attachment to a person to be monitored,
(ii) receiving an analysis of vibration measurements from the dosimeter and storing said analysis on a database correlated with identifying details of the person being monitored,
(iii) processing said analysis so as to create a vibration exposure report for the individual being monitored, and
(iv) providing the vibration exposure report to the person being monitored or to an organisation with which the person is affiliated.

In the case of an employee, the vibration exposure report may be provided to the employer of the person being monitored.

The invention will now be described, by example only, with reference to the accompanying drawings in which;

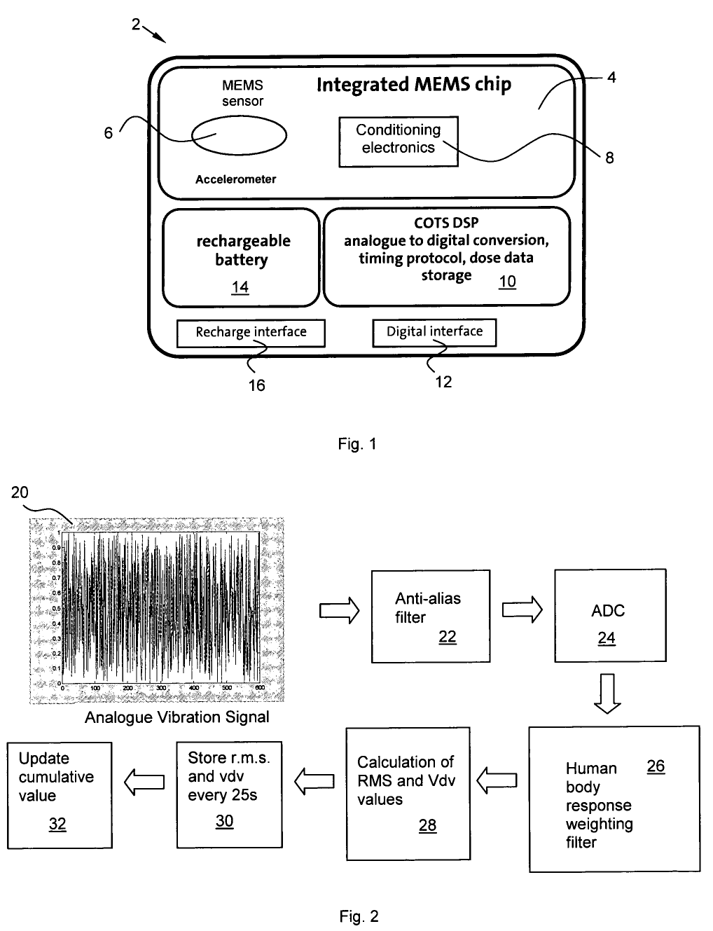

FIG. 1 shows a schematic block diagram of a personal whole-body vibration dosimeter according to one embodiment of the present invention.

FIG. 2 shows a schematic block diagram illustrating typical data processing steps performed by the whole-body vibration dosimeter of FIG. 1.

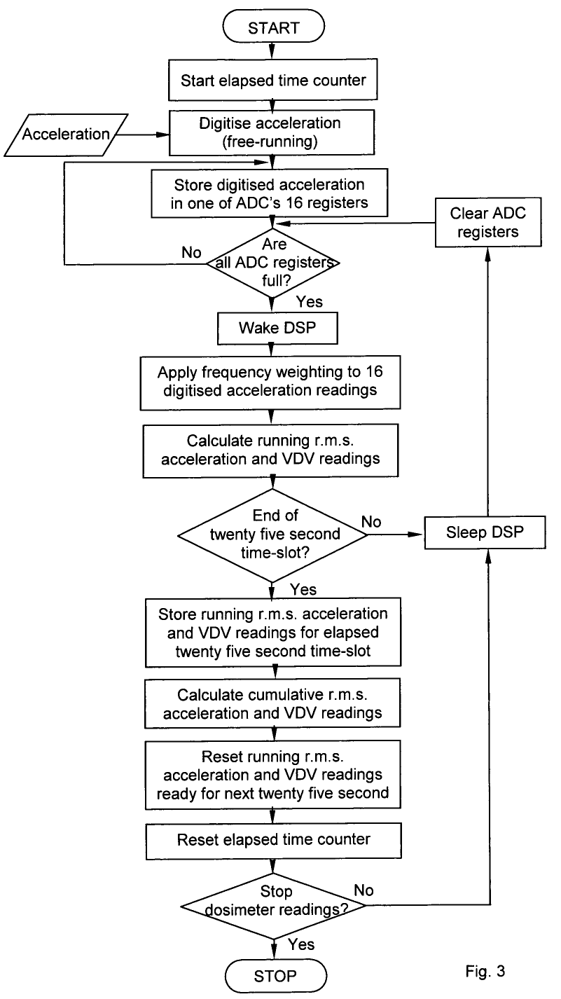

FIG. 3 shows a flow diagram illustrating the specific manner in which the dosimeter processes acceleration measurements in order to minimise internal power consumption.

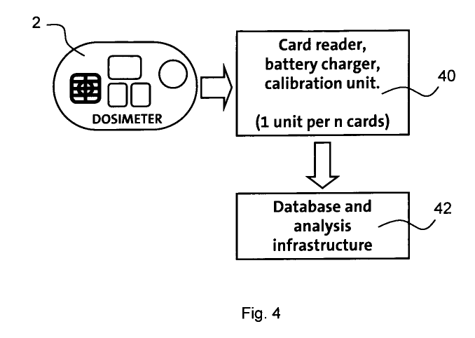

FIG. 4 illustrates a data management system according to another embodiment of the present invention for retrieving vibration data from the dosimeter(s) of FIG. 1 and for analysing and storing the retrieved data.

Referring now to the drawings wherein like reference numerals identify corresponding or similar elements throughout the several views, FIG. 1 shows a personal whole-body vibration dosimeter according to one embodiment of the present invention.

The dosimeter has an unobtrusive, ergonomic design to facilitate attachment to the body. By way of example of the compactness of the present design, the dosimeter 2 typically has outer dimensions 56 mm×40 mm×9 mm. In use the dosimeter 2 is worn on a belt or incorporated into webbing as part of a uniform where appropriate. The dosimeter 2 is worn at the base of the spine. Alternatively, in applications where seat configuration may adversely affect measurements (e.g. where a backrest is present), the dosimeter is worn at the iliac crest (hip bone).

The personal dosimeter 2 comprises a self contained unit incorporating a micro-electromechanical-systems (MEMS) accelerometer 6, associated signal conditioning electronics 8, and a digital signal processor 10.

Specifically, the MEMS accelerometer 6 is a single-axis, optionally multiple-axis, analogue device capable of measuring peak accelerations in the range ±10 g. Where high levels of vibrations are anticipated, the accelerometer 6 is capable of measuring accelerations in the range ±25 g. In the case of a single-axis accelerometer, the measurement axis is aligned in use in a substantially vertical direction (z-axis). In the case of a multiple-axis accelerometer, the measurement axes are substantially orthogonal and the measurement axes are aligned so as to measure whole-body vibration in the vertical axis (z-axis) and the two lateral axes (x-axis and y-axis).

Signal conditioning electronics 8 are provided within the dosimeter 2 in order to pre-process the analogue vibration signal produced by the MEMS accelerometer 6 prior to digitisation thereof. The signal conditioning electronics 8 include a low-pass filter adapted to pass signals having frequencies up to 100 Hz. The low-pass filter acts as an anti-alias filter.

The dosimeter 2 includes a Digital Signal Processor (DSP) 10 comprising an analogue to digital converter (ADC) arranged to digitise the pre-processed analogue acceleration signal, a digital signal processor configured to calculate periodic and cumulative weighted root-mean-square (r.m.s.) accelerations and vibration dose values from the digitised acceleration data, and a data store configured to store the periodic and cumulative weighted r.m.s. accelerations and vibration dose values.

Vibration exposure levels in the form of r.m.s. accelerations and vibration dose values (VDVs)) recorded by the dosimeter are accessible via digital interface 12.

The dosimeter 2 is powered by an internal rechargeable battery 14 which is chargeable by an external charger (not shown in FIG. 1) via a recharge interface 16. The battery 14 comprises a 3 Volt lithium-polymer cell having a high charge storage capacity, for example in the range 100 mAh-200 mAh. The high storage capacity of the battery 14 contributes to the successful operation of the present dosimeter 2 since it enables the dosimeter to measure and record vibration exposure levels over extended time periods, e.g. eight hours to forty-eight hours between charges.

FIG. 2 shows a schematic block diagram illustrating typical data processing steps performed by the whole-body vibration dosimeter of FIG. 1. During use, the MEMS accelerometer 6 produces an analogue acceleration signal 20 (or a plurality of signals in the case of a multi-axis accelerometer; typically one signal being produced for each measurement axis). The amplitude of the acceleration signal is proportional to the magnitude of the acceleration experienced by the person wearing the dosimeter 2.

The acceleration signal 20 is filtered by the anti-alias filter 22 (part of the conditioning electronics 8) and is then digitised by the Analogue to digital Converter (ADC) 24 within the DSP 10. The ADC 24 continuously samples the acceleration signal at a sampling frequency of 500 Hz, thereby ensuring that any transient vibration peaks or shocks are captured by the dosimeter 2. The minimum useable sampling frequency is about 200 Hz, whereas the maximum sampling frequency is only limited by the amount of processing power available within the dosimeter.

The digitised acceleration data forms the basis from which periodic and cumulative weighted root-mean-square (r.m.s.) accelerations and vibration dose values are calculated within the dosimeter 2. Indeed, it is this step 28 of processing the acceleration time histories in real-time to derive r.m.s. accelerations and vibration dose values which differentiates the present dosimeter 2 over other personal vibration monitors described above. Furthermore, processing acceleration time histories in this manner enables the dosimeter to store detailed vibration dosage information corresponding with extended exposure periods (specifically daily exposures) which would otherwise be unfeasible due to memory and power limitations within the dosimeter 2.

The digitised acceleration data is filtered through a human body response weighting filter 26 in order that the vibration exposure levels measured by the dosimeter 2 are compliant with the applicable standards relating to measurement and evaluation of mechanical vibration. For example, International Standard ISO 2631-1:1997 relates to measurement and evaluation of human exposure to whole body mechanical vibration and shock.

The human body response weighting filter 26 applies a correction to the digitised acceleration data to reflect the fact that the human body reacts to vibration having different frequencies in different ways. In this manner the frequency dependant sensitivity of the human body to vibration is accounted for by multiplying factors within the filter 26. In the case of whole-body vibration, the human body response weighting filter 26 passes all frequencies in a range 0.1 Hz to 80 Hz and attenuates all acceleration figures outside this range. Inside the pass-band, the frequency weighting is applied to reflect the exposure standard. Different frequency weightings are applied to the digitised acceleration data depending on the direction of vibration transmitted to the body (x, y, or z-axis), points of transmission and body position (e.g. seated position, standing position or recumbent position). This is particularly important where the dosimeter 2 is a multiple-axis device.

Optionally, the human body response weighting filter is modified to compensate for the expected complex (i.e. incorporating both modulus and phase) transfer function between the seat surface and the dosimeter position. Different transfer functions are applied according to the anticipated position of the dosimeter on the body.

The frequency weighted acceleration data is subsequently processed by the DSP 10 to provide two important measures of vibration exposure, namely periodic and cumulative root-mean-square frequency-weighted acceleration and vibration dose values.

Frequency-weighted r.m.s. acceleration is the basic measure of vibration magnitude used for the evaluation of whole-body vibration and is calculated by the dosimeter 2 using the formula shown in Equation 1 below. Frequency-weighted r.m.s. acceleration (a_{w}) is one of the factors used to determine the daily exposure to vibration (A(8)) of a person as defined in the U.K. Control of Vibration at Work Regulations 2005.

Fourth-power Vibration Dose Value (referred to in the appropriate standards and legislation as VDV) is the preferred measure of vibration magnitude for the evaluation of whole-body vibration in situations where the vibration contains transient vibrations or shocks. VDV is more sensitive to vibration peaks than frequency-weighted r.m.s. acceleration since the former uses a fourth power of the acceleration time history rather than a second power of the acceleration time history used in the latter.

Managing the energy budget has been a major factor throughout the design of the present dosimeter 2 and reducing the amount of energy consumed by the DSP 10 has been a key driver. Accordingly, the specific manner in which the DSP 10 determines frequency-weighted r.m.s. acceleration (a_{w}) and vibration dose value (VDV) has important implications for the power consumption of the device and consequently on the length of time for which the dosimeter can operate before the internal battery 14 requires recharging.

FIG. 3 shows a flow diagram illustrating the specific manner in which dosimeter 2 processes the acceleration signals 20 in order to minimise internal power consumption.

The key factor in managing the limited power budget is to minimise the power consumption of the DSP. This is achieved by using a device in which the core of the DSP 10 can be placed in a low-power “sleep-mode” or “idle-mode” whilst the ADC remains active to process and store acceleration measurements. The core of the DSP 10 is periodically woken to process batches of digitised acceleration readings, each batch comprising sixteen readings. Typically, the DSP comprises a microcontroller with hardware multiplication capability and optimisations for performing digital signal processing functions such as filtering. Additionally, to minimise the number of chips used, the DSP contains the ADC, serial communications port, and sufficient memory to hold the recorded data. Furthermore, to maximise operating time on a single battery charge, the DSP contains power saving functions to allow it to enter a sleep mode whilst not processing data. By way of specific example, the DSP 10 used within the dosimeter 2 comprised a Microchip dsPIC 30F6012 digital signal peripheral interface controller.

Referring to FIG. 3, the dosimeter 2 is configured to calculate and record frequency-weighted r.m.s. acceleration (a_{w}) and vibration dose value (VDV) on a running basis for contiguous recording periods. Additionally, cumulative frequency-weighted r.m.s. acceleration and cumulative vibration dose value are calculated and stored in respect of the period for which the dosimeter 2 has been in use, for example for each day's use. The cumulative frequency-weighted r.m.s. acceleration and cumulative vibration dose value are updated using the most recent running frequency-weighted r.m.s. acceleration (a_{w}) and running vibration dose value at the end of each recording period. The duration of the recording period (twenty-five seconds in the present system) determines the temporal resolution for the dosimeter 2 and is determined by the amount of memory available to store the data and the length of time over which the data needs to be recorded. The abovementioned contiguous recording periods are controlled by an elapsed time counter within the DSP 10 which is reset at the end of each twenty-five second recording period.

Upon activating the dosimeter 2, the DSP 10 adopts the lower power “sleep-mode”. The elapsed time counter is reset and initiated. Acceleration measurements from the accelerometer 6 are digitised at a sampling frequency of 500 Hz and successive digitised instantaneous acceleration measurements recorded temporarily in registers internal to the ADC 24. Consecutive digitised instantaneous acceleration measurements are recorded until all the ADC registers (sixteen in the case of the present DSP 10) have been filled. The DSP 10 core is now woken to process the batch of digitised acceleration measurements temporarily held in the ADC registers.

All the processing functions of the DSP core are activated in the “active-mode” and hence the power consumption of the DSP 10 is increased compared with that of the DSP 10 when in “sleep-mode”. The DSP 10 processes the batch of digitised acceleration measurements by firstly applying the human body response weighting filter 26 to the digitised acceleration measurements by way of a digital filter. The DSP 10 then calculates running frequency-weighted r.m.s. acceleration (a_{w}) and running vibration dose value (VDV) for the first batch of acceleration measurements and temporarily stores the running totals awaiting the next batch of digitised acceleration measurements.

The DSP core reverts to the “sleep-mode” while another batch of acceleration measurements are digitised and stored, at which point the processor is woken again. The DSP 10 then recalculates running frequency-weighted r.m.s. acceleration (a_{w}) and running vibration dose value (VDV) using the first and second batches of acceleration measurements and updates the temporary running totals awaiting the next batch of digitised acceleration measurements. The DSP core reverts to the “sleep-mode” while another batch of acceleration measurements are digitised and stored, at which point the processor is woken again.

The above process of updating the running frequency-weighted r.m.s. acceleration (a_{w}) and running vibration dose value (VDV) using successive batches of acceleration measurements is repeated until the twenty-five second recording period is complete. The running frequency-weighted r.m.s. acceleration (a_{w}) and running vibration dose value (VDV) are calculated and archived within the dosimeter 2 against the corresponding twenty-five second recording period for subsequent retrieval and analysis. The DSP 10 also updates the cumulative frequency-weighted r.m.s. acceleration and cumulative vibration dose value at this stage.

Specifically, the running frequency-weighted r.m.s. acceleration (a_{w}) is calculated within the dosimeter 2 using the equation shown below in Equation 1,

$${a}_{w} = \sqrt{1 / n {\sum }_{i = 1}^{n} {( {a}_{w} ( t ) )}^{2}} \qquad ( Equation 1 )$$

where a_{w}(t) is the instantaneous frequency-weighted acceleration and n is the number of acceleration measurements taken during the twenty-five second recording period.

The dosimeter 2 calculates running vibration dose value (VDV) for each recording period using the equation shown below in Equation 2

$$V D V = \sqrt[4]{{\sum }_{i = 1}^{n} {( {a}_{w} ( t ) )}^{4}} \qquad ( Equation 2 )$$

where a_{w}(t) is the instantaneous frequency-weighted acceleration and n is the number of acceleration measurements taken during the twenty-five second recording period.

The cumulative vibration dose value (VDV_{cumulative}) in respect of the period for which the dosimeter has been in use is calculated within the dosimeter 2 by summing the individual running vibration dose values (VDVᵢ) for all elapsed recording periods using the using the equation shown below in Equation 3,

VDV_{cumulative}=⁴{square root over ((Σ(VDVᵢ)⁴))} (Equation 3)

where VDVᵢ is the individual running vibration dose value for the particular recording period i, where i=1−N (N being the total number of recording periods).

The registers within the DSP 10 in which the running frequency-weighted r.m.s. acceleration (a_{w}) and running vibration dose value have been temporarily stored are reset in readiness for the next twenty-five second recording period. The elapsed time counter is reset, as are the ADC registers, and the DSP core is placed in the low-power “sleep-mode”. The elapsed time counter is subsequently restarted heralding the start of the next twenty-five second recording period.

The above process is repeated until all vibration measurements have been recorded at which point the dosimeter 10 may be turned off. The running frequency-weighted r.m.s. acceleration (a_{w}) and running vibration dose value (VDV) for each twenty-five second recording period are retained within the dosimeter 2 along with the cumulative frequency-weighted r.m.s. acceleration and cumulative running vibration dose value for subsequent retrieval and analysis.

Referring now to FIG. 4, vibration exposure data acquired by the dosimeter 2 is retrieved and analysed by a data management system comprising a dosimeter reader 40 interfaced to a personal-computer (PC). The reader 40 is adapted to receive a single dosimeter, optionally a plurality of dosimeters 2. The reader ∝includes a serial communication interface which is arranged in use to communicate with the digital interface 12 within the dosimeter 2 to transfer the vibration exposure data from the dosimeter 2 to a database 42 held on the PC. Without limitation, the database comprises a Microsoft® Access database with associated bespoke code to control data transfer and analysis, and a graphical user interface (GUI). Optionally, the reader 40 includes internal memory (e.g. flash memory) configured to temporarily hold vibration exposure data prior to transfer to the database 42 held on the PC. This configuration is beneficial where a PC is not always available, e.g. where the reader 40 is used in the field. The reader 40 is typically interfaced to the PC via a USB interface which also provides electrical power for the reader. Alternatively, the reader 40 may be remote to the PC and communicate there-with via a communications network, e.g. a local area network (LAN), a wire-less network, a web-based internet connection etc. In this case, the reader 40 has its own separate power supply. The reader 40 also includes a charger adapted to recharge the dosimeter 2 via the recharge interface 16. Alternatively, a separate charger may be used to recharge the dosimeter 2.

The process by which vibration exposure data is retrieved and analysed is as follows.

Prior to use, each dosimeter 2 is assigned an identification number for the purpose of correlating the recorded vibration exposure data with a person to whom the dosimeter is issued. This step is performed electronically by inserting the dosimeter 2 into the reader 40 the first time (or each time) the dosimeter 2 is used. Accordingly, the PC is subsequently able to automatically store vibration exposure data from a particular dosimeter against a specific user within the database.

Following assignment of an identification number, the dosimeter 2 is ready for use and requires no further intervention on the part of the wearer other than attachment by the person being monitored at an appropriate position on the body. The dosimeter 2 now records vibration exposure levels for subsequent retrieval and analysis by the reader 40 and associated PC.

Upon completion of vibration exposure measurements, the dosimeter is returned to the reader 40 and the frequency-weighted r.m.s. acceleration (a_{w}) and vibration dose value (VDV) time histories are down-loaded along with the cumulative frequency-weighted r.m.s. acceleration and cumulative vibration dose for the given measurement period.

The vibration exposure data is recorded in the database 42 for the specific user and is subsequently processed by analysis software. The analysis software calculates the quantity of mechanical vibration to which the user has been exposed during the day 5 (referred to as the daily exposure level and denoted in the legislation by the term A(8)) from the frequency-weighted r.m.s. acceleration (a_{w}) time history data. The daily exposure level is calculated using the following formula (Equation 4),

$$A ( 8 ) = \sqrt{1 / {T}_{0} {\sum }_{i = 1}^{N} {a}_{w}^{2} {T}_{i}} \qquad ( Equation 4 )$$

where a_{w} is the running frequency-weighted r.m.s. acceleration for each recording period, N is the total number of recording periods for which a_{w} has been measured and calculated, Tᵢ is the duration of the recording period (twenty-five seconds in the present system), and T₀ is the reference duration of eight hours (28,800 seconds).

The analysis software also provides an indication of whether the daily exposure level received by the user of the dosimeter 2 is within acceptable limits and provides a warning in the event that the daily exposure limit value or action value is exceeded (1.15 m/s² and 0.5 m/s² respectively as defined in the appropriate legislation and standards).

In view of the foregoing description it will be evident to a person skilled in the art that various modifications may be made within the scope of the invention.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived there from. In particular, with reference to the appended claims, features from dependent claims may be combined with those of the independent claims and features from respective independent claims may be combined in any appropriate manner and not merely in the specific combinations enumerated in the claims.

1. A vibration dosimeter adapted to monitor whole-body vibration comprising a sensor arranged in use to continuously measure magnitude of mechanical vibrations, sampling circuitry for sampling the vibration measurements produced by the sensor, and a processor configured to analyse the vibration measurements to determine whole-body vibration and to record an analysis thereof in a data store internal to the dosimeter.

2. A vibration dosimeter according to claim 1 adapted in use to be worn on or at the hip of a person being monitored.

3. A vibration dosimeter according to claim 1 adapted in use to be worn on or at the base of the spine of a person being monitored.

4. A vibration dosimeter according to claim 1 further comprising a filter for filtering the sampled vibration measurements so as to emphasise vibrations corresponding substantially with modes of vibration of the human body.

5. A vibration dosimeter according to claim 1 wherein the analysis comprises a frequency weighted root-mean-square acceleration time-history.

6. A vibration dosimeter according to claim 5 wherein the analysis comprises cumulative frequency-weighted root-mean-square acceleration.

7. A vibration dosimeter according to claim 1 wherein the analysis comprises a frequency-weighted vibration dose value time-history.

8. A vibration dosimeter according to claim 7 wherein the analysis comprises cumulative frequency-weighted vibration dose value.

9. (canceled)

10. A vibration dosimeter according to claim 1 having a power consumption which is controllable in use by switching the processor between an active state and a sleep state.

11. A vibration dosimeter according to claim 10 wherein, in use, the processor adopts the sleep state while the sampling circuitry samples and temporarily stores a plurality of vibration measurements produced by the sensor.

12-13. (canceled)

14. A vibration dosimeter according to claim 1 wherein the sensor comprises a micro-electromechanical-systems (MEMS) accelerometer having a plurality of measurement axes.

15. A vibration dosimeter according to claim 1 wherein the sensor comprises a micro-electromechanical-systems (MEMS) accelerometer having a single measurement axis.

16-18. (canceled)

19. An apparatus for analysing whole-body vibration comprising a dosimeter according to claim 1 and a dosimeter reader for retrieving the analysis of the vibration measurements from the dosimeter.

20. An apparatus according to claim 19 comprising a computer arranged in use to receive the analysis of the vibration measurements from the dosimeter reader and to store the analysis in a database.

21. An apparatus according to claim 20 adapted to identify from the analysis of the vibration measurements any vibration exposure in excess of a daily exposure limit value.

22. An apparatus according to claim 20 adapted to identify from the analysis of the vibration measurements any vibration exposure in excess of a daily exposure action value.

23. An apparatus according to claim 20 adapted to calculate daily vibration exposure from the analysis of the vibration measurements.

24. A method of measuring whole-body vibration exposure comprising the steps of:
(i) attaching to a person to be monitored a vibration dosimeter according to claim 1,
(ii) measuring magnitude of mechanical vibrations received by the person being monitored,
(iii) analysing the vibration measurements and recording the analysis thereof in a data store internal to the dosimeter,
(iv) retrieving the analysis of the vibration measurements from the dosimeter, and
(v) storing the analysis of the vibration measurements in a database.

25. A method according to claim 24 wherein the step of attaching the vibration dosimeter to the person to be monitored comprises attaching the dosimeter on or at the hip of the person to be monitored.

26. A method according to claim 24 wherein the step of attaching the vibration dosimeter to the person to be monitored comprises attaching the dosimeter on or at the base of the spine of the person to be monitored.

27. A method according to claim 24 comprising the further step of:
(vi) calculating daily vibration exposure from the analysis of the vibration measurements.

28. A method according to claim 27 comprising the further step of:
(vii) identifying from the analysis of the vibration measurements any vibration exposure in excess of a daily exposure limit value.

29. A method according to claim 28 comprising the further step of:
(viii) identifying from the analysis of the vibration measurements any vibration exposure in excess of a daily exposure action value.
